(19) United States
(12) Patent Application Publication
(10) Pub. No.: US 2014/0178203 A1
(43) Pub. Date: Jun. 26, 2014

(54) COATING FIXTURES FOR GAS TURBINE ENGINE COMPRESSOR DISKS

(71) Applicant: SOLAR TURBINES INCORPORATED, San Diego, CA (US)

(72) Inventor: Yuchin Kang, Chula Vista, CA (US)

(73) Assignee: SOLAR TURBINES INCORPORATED, San Diego, CA (US)

(21) Appl. No.: 13/725,368

(22) Filed: Dec. 21, 2012

(51) Int. Cl. B05D 3/12; F01D 5/00

(52) U.S. Cl. CPC B05D 3/12; F01D 5/00
USPC 416/223 R; 427/300; 118/505

(57) ABSTRACT

A method for coating a gas turbine engine compressor rotor having a compressor disk with axial slots includes inserting masking fixtures into the axial slots. Each masking fixture includes a masking root that matches the shape of a blade root of an axial blade configured to be inserted into the axial slot the masking fixture is inserted into. The method also includes applying a coating to the compressor rotor after inserting the masking fixtures into the axial slots followed by drying the coating on the compressor rotor at a predetermined temperature. The method further includes removing the masking fixtures from the axial slots after drying the coating on the compressor rotor followed by curing the coating on the compressor rotor.

### TECHNICAL FIELD

the present disclosure generally pertains to overspray masking fixtures, and is more particularly directed toward Coating fixtures for gas turbine engine compressor disks.

### BACKGROUND

Gas turbine engines include compressor, combustor, and turbine sections. Components of these sections may be coated to protect the surfaces of the components. Some surfaces of the components may not receive the coating and may need to be masked during the coating process.

U.S. Pat. No. 6,875,476 to P. Hawtin discloses a method for masking at least one turbine engine component wherein the method includes providing at least one masking member, securing each masking member to the at least one turbine engine component, and applying a metal coating to the at least one turbine engine component.

The present disclosure is directed toward overcoming one or more of the problems discovered by the inventors.

### SUMMARY OF THE DISCLOSURE

A method for coating a gas turbine engine compressor rotor including a compressor disk having axial slots is disclosed. The method includes inserting masking fixtures into the axial slots. Each masking fixture includes a masking root that matches the shape of a blade root of an axial blade configured to be inserted into the axial slot the masking fixture is inserted into. The method also includes applying a coating to the compressor rotor after inserting the masking fixtures into the axial slots. The method includes drying the coating on the compressor rotor at a predetermined temperature after applying the coating to the compressor rotor and before curing the coating on the compressor rotor. The method also includes removing the masking fixtures from the axial slots after drying the coating on the compressor rotor and before curing the coating on the compressor rotor. The method further includes curing the coating on the compressor rotor.

A masking fixture for inserting into a gas turbine engine compressor disk axial slot during a spray coating process is also disclosed. The masking fixture includes a masking root having a shape that matches the shape of a blade root of an axial blade configured to be inserted into the axial slot the masking fixture is inserted into. The masking fixture also includes a material having a heat deflection temperature greater than 93.3 degrees Celsius. The masking root is configured to cover all portions of the axial slot that contact the axial blade.

### BRIEF DESCRIPTION OF THE DRAWINGS

FIG. 1 is a schematic illustration of an exemplary gas turbine engine.

FIG. 2 is a perspective view of the compressor rotor of the gas turbine engine of FIG. 1 with compressor rotor blades.

FIG. 3 is a cross-sectional view of the forward weldment of the compressor rotor of FIG. 2.

FIG. 4 is a perspective view of a portion of a compressor disk with an embodiment of a masking fixture including a handle.

FIG. 5 is a perspective view of a portion of a compressor disk with an embodiment of a masking fixture including a masking platform.

FIG. 6 is a flowchart of a method for coating a gas turbine engine compressor rotor with at least one compressor disk.

### DETAILED DESCRIPTION

The systems and methods disclosed herein include covering the compressor disk axial slots of a gas turbine engine compressor rotor with masking fixtures while coating the compressor rotor. In embodiments, the masking fixtures include a rigid masking root. The masking root may prevent or limit overspray from occurring on the surfaces of the axial slots during the coating process. Overspray on the axial slot surfaces may cause fretting to occur.

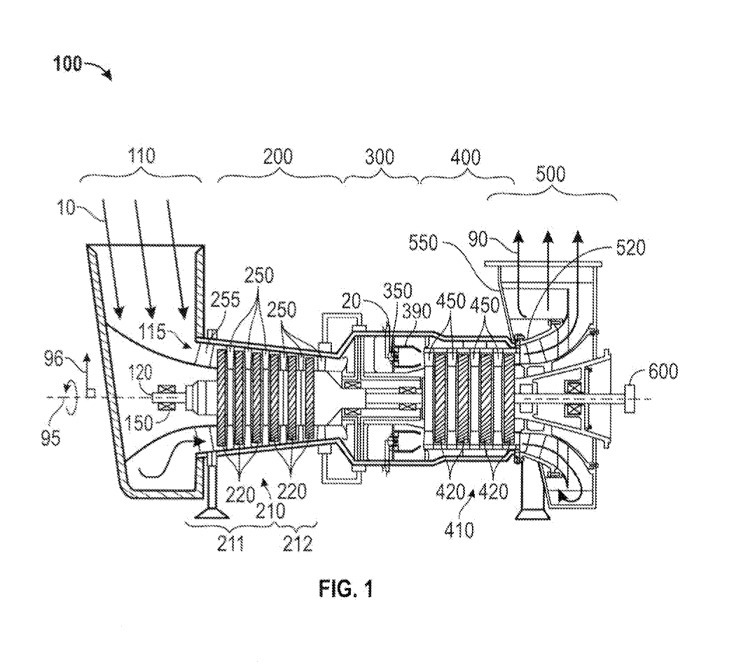

FIG. 1 is a schematic illustration of an exemplary gas turbine engine. Some of the surfaces have been left out or exaggerated (here and in other figures) for clarity and ease of explanation. Also, the disclosure may reference a forward and an aft direction. Generally, all references to “forward” and “aft” are associated with the flow direction of primary air (i.e., air used in the combustion process), unless specified otherwise. For example, forward is “upstream” relative to primary air flow, and aft is “downstream” relative to primary air flow.

In addition, the disclosure may generally reference a center axis 95 of rotation of the gas turbine engine, which may be generally defined by the longitudinal axis of the shaft 120 (supported by a plurality of bearing assemblies 150). The center axis 95 may be common to or shared with various other engine concentric components. All references to radial, axial, and circumferential directions and measures refer to center axis 95, unless specified otherwise, and terms such as “inner” and “outer” generally indicate a lesser or greater radial distance from wherein a radial 96 may be in any direction perpendicular and radiating outward from center axis 95.

A gas turbine engine 100 includes an inlet 110, a shaft 120, a gas producer or “compressor” 200, a combustor 300, a turbine 400, an exhaust 500, and a power output coupling 600. The gas turbine engine 100 may have a single shaft or a dual shaft configuration.

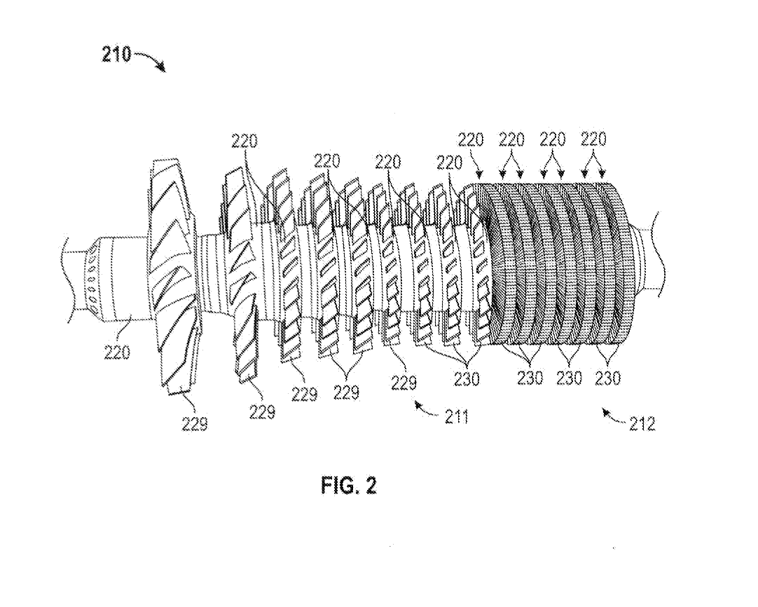

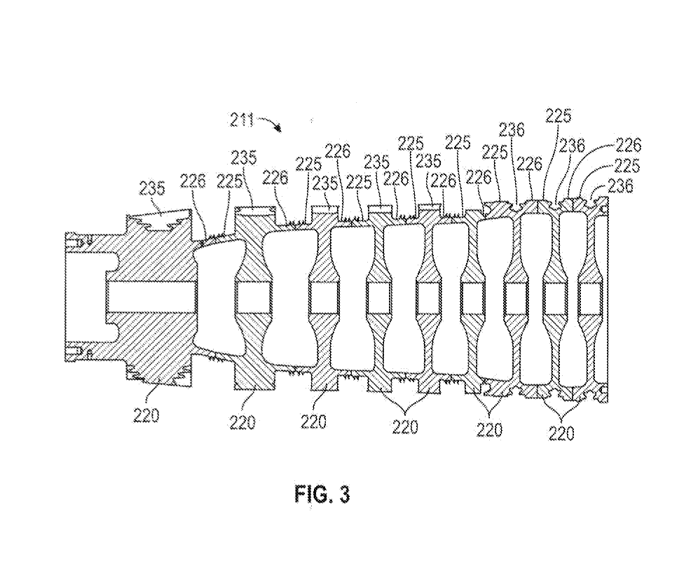

FIG. 2 is a perspective view of the compressor rotor 210 of FIG. 1 with compressor rotor blades. Referring to FIGS. 1 and 2, the compressor 200 includes a compressor rotor 210, compressor rotor blades, compressor stationary vanes (“stators”) 250, and inlet guide vanes 255. The compressor rotor 210 mechanically couples to shaft 120. As illustrated, the compressor rotor 210 is part of an axial flow rotor assembly. The compressor rotor 210 may include one or more weldments. In the embodiment illustrated compressor rotor 210 includes a forward weldment 211 and an aft weldment 212. Each weldment includes one or more compressor disks generally indicated as 220 (shown in FIGS. 2 and 3). Each compressor disk 220 is circumferentially populated with compressor rotor blades (shown in FIG. 2). Some of the surfaces of each weldment or compressor disk 220 may be coated with a protective coating such as an aluminum coating.

Compressor disks 220 may have axially installed compressor rotor blades (“axial blades”) 229 or circumferentially installed compressor rotor blades (“circumferential blades”) 230. Compressor rotor blade sizes may be determined by the sizes of the compressor disks 220.

Stators 250 axially follow each of the compressor disks 220. Each compressor disk 220 with compressor rotor blades paired with the adjacent stators 250 that follow the compressor disk 220 is considered a compressor stage. Compressor 200 includes multiple compressor stages. Inlet guide vanes 255 axially precede the forward most compressor stage.

Referring again to FIG. 1, the combustor 300 includes one or more injectors 350 and includes one or more combustion chambers 390.

The turbine 400 includes a turbine rotor assembly 410 and turbine nozzles 450. The turbine rotor assembly 410 mechanically couples to the shaft 120. As illustrated, the turbine rotor assembly 410 is an axial flow rotor assembly. The turbine rotor assembly 410 includes one or more turbine disk assemblies 420. Each turbine disk assembly 420 includes a turbine disk that is circumferentially populated with turbine blades. Some of the surfaces of each turbine disk assembly 420 may be coated with a protective coating such as a thermal barrier coating. Turbine nozzles 450 axially precede each of the turbine disk assemblies 420. Each turbine disk assembly 420 paired with the adjacent turbine nozzles 450 that precede the turbine disk assembly 420 is considered a turbine stage. Turbine 400 includes multiple turbine stages.

The exhaust 500 includes an exhaust diffuser 520 and an exhaust collector 550.

FIG. 3 is a cross-sectional view of the forward weldment 211 of the compressor rotor 210 of FIG. 2. The forward weldment 211 includes multiple compressor disks generally indicated as 220, though they may not be identical in size and configuration.

Each compressor disks 220 may include a forward welding member 225 and an aft welding member 226. However, the first compressor disk may only have an aft welding member 226 and the last compressor disk may only have a forward welding member 225. The forward welding member 225 may have an annular shape and may extend forward from the compressor disk 220. The aft welding member 226 may have an annular shape and may extend aft from the compressor disk 220. The aft welding member 226 of a compressor disk 220 may be welded to the forward welding member 225 of the subsequent compressor disk 220. In the embodiment shown, the forward weldment 211 includes nine compressor disks 220.

Each compressor disk 220 of forward weldment 211 may include axial slots 235 or a circumferential slot 236. Axial slots 235 include a fir tree or dovetail cross-sectional shape and extend substantially in the axial direction through the compressor disk 220. Circumferential slots 236 may also have a dovetail shape and extend circumferentially around the compressor disk 220. Each compressor disk with axial slots 235 includes multiple axial slots 235. Axial slots 235 for a single compressor disk 220 generally have the same shape. The axial slots 235 for some compressor disk 220 may have a unique shape and cross-section. Axial slots 235 for other compressor disks 220 may share the same shape and cross-section. If the compressor disk 220 includes axial slots 235, one axial blade 229 may be inserted into each axial slot 235. If the compressor disk 220 includes a circumferential slot 236, multiple circumferential blades 230 may be inserted into the circumferential slot 236. Axial blades 229 include an airfoil, a platform and a blade root. The blade roots are shaped to match the fir tree or dovetail cross-sectional shapes of the axial slots 235.

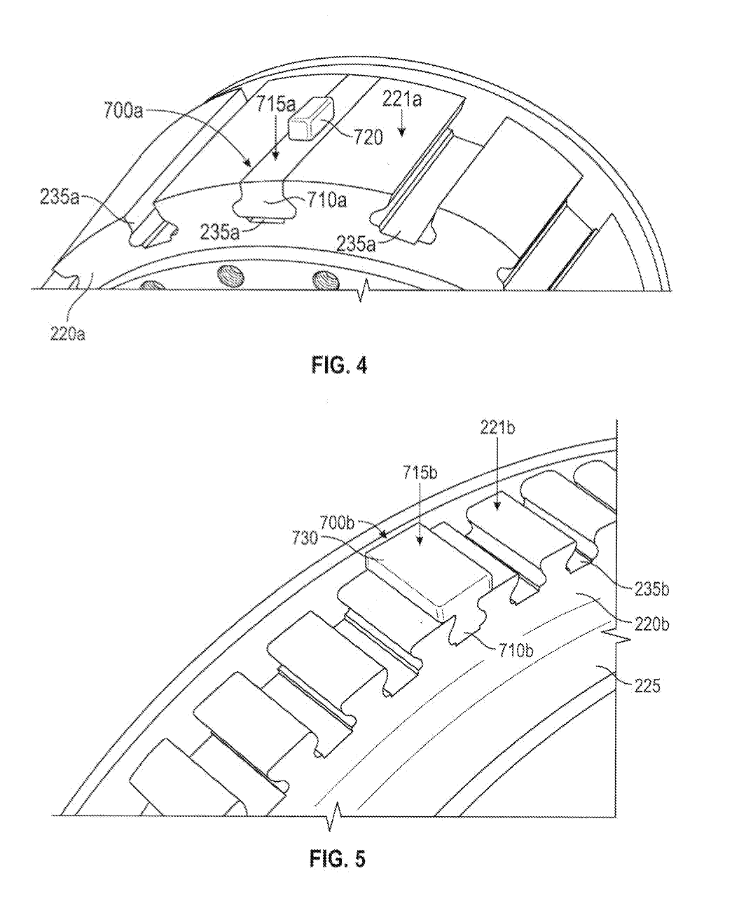

FIG. 4 is a perspective view of a portion of an exemplary compressor disk 220a with an embodiment of a masking fixture 700a with a handle 720. FIG. 5 is a perspective view of a portion of an exemplary compressor disk 220b with an embodiment of a masking fixture 700b with a masking platform 730. Each masking fixture includes a masking root. In the embodiment shown in FIG. 4, masking root 710a matches the dimensions, size, and shape of a blade root of an axial blade 229, masking most of the axial slot 235a. As illustrated in FIG. 4, the masking root 710a may be configured to cover all portions of the axial slot 235a that will contact the axial blade 229. A small gap may be located between the bottom of masking root 710a and the bottom of axial slot 235a where the axial blade 229 will not contact the axial slot 235a when installed. In the embodiment shown in FIG. 5, masking root 710b is the negative of axial slot 235b of a compressor disk 220b, completely masking every surface of the axial slot 235b. As illustrated in FIG. 5, the masking root 710b may be configured to completely fill axial slot 235b.

Masking fixtures such as masking fixtures 700a and 700b may each include an outer fixture surface such as outer fixture surfaces 715a and 715b and compressor disks 220 may each include an outer disk surface such as outer disk surfaces 221a and 221b. In the embodiment shown in FIG. 4, outer fixture surface 715a is flush with outer disk surface 221a; masking fixture 700a includes a handle 720 extending from masking root 710a. Handle 720 may extend from outer fixture surface 715a.

In the embodiment shown in FIG. 5, outer fixture surface 715b is located radially outward from outer disk surface 221b; masking fixture 700b includes masking platform 730. Masking platform 730 may extend the length of the dovetail shape of masking root 710b and may match the shape of an axial blade platform. Masking platform 730 is attached to or extends from masking root 710b and may be located radially outward from compressor disk 220b when masking fixture 700b is installed within an axial slot 235b of the compressor disk 220b. Masking platform 730 may overhang a portion of the outer disk surface 221b, matching the amount an axial blade platform overhangs the outer disk surface 221b when installed in the compressor disk 220b. Masking platform 730 and masking root 710b may form a T-shaped cross-section.

Multiple sized and shaped masking fixtures may be used for a single compressor rotor 210 or weldment due to the varying sizes of axial slots 235 from one compressor disk 220 to another. In some embodiments, the same masking fixture may be used for multiple compressor stages. In one embodiment, the same masking fixture is used for three contiguous compressor disk 220, such as compressor disks 220 in a second stage, a third stage, and a fourth stage of the compressor rotor 210.

One or more of the above components (or their subcomponents) may be made from stainless steel and/or durable, high temperature materials known as “superalloys”. A superalloy, or high-performance alloy, is an alloy that exhibits excellent mechanical strength and creep resistance at high temperatures, good surface stability, and corrosion and oxidation resistance. Superalloys may include materials such as HASTELLOY, INCONEL, WASPALOY, RENE alloys, HAYNES alloys, INCOLOY, MP98T, TMS alloys, and CMSX single crystal alloys.

Masking fixtures may also be made from polymers, plastics, rubbers, or composite materials. In some embodiments, a polymer or a plastic with a heat deflection temperature greater than 93.3 degrees Celsius (200 degrees Fahrenheit) is used. The heat deflection temperature is the temperature at which a polymer or plastic deforms under a specified load. In one embodiment, acrylonitrile butadiene styrene (“ABS-M30”) is used. In another embodiment, polyphenylsulfone (“ppsf”) is used. Masking fixtures may be formed from manufacturing processes such as stereolithography, molding, and machining.

### INDUSTRIAL APPLICABILITY

Gas turbine engines may be suited for any number of industrial applications such as various aspects of the oil and gas industry (including transmission, gathering, storage, withdrawal, and lifting of oil and natural gas), the power generation industry, cogeneration, aerospace, and other transportation industries.

Referring to FIG. 1, a gas (typically air 10) enters the inlet 110 as a “working fluid”, and is compressed by the compressor 200. In the compressor 200, the working fluid is compressed in an annular flow path 115 by the series of compressor disks 220 with compressor rotor blades. In particular, the air 10 is compressed in numbered “stages”, the stages being associated with each compressor disk 220. For example, “4th stage air” may be associated with the 4th compressor disk 220 in the downstream or “aft” direction, going from the inlet 110 towards the exhaust 500). Likewise, each turbine disk assembly 420 may be associated with a numbered stage.

Once compressed air 10 leaves the compressor 200, it enters the combustor 300, where it is diffused and fuel 20 is added. Air 10 and fuel 20 are injected into the combustion chamber 390 via injector 350 and combusted. Energy is extracted from the combustion reaction via the turbine 400 by each stage of the series of turbine disk assemblies 420. Exhaust gas 90 may then be diffused in exhaust diffuser 520, collected and redirected. Exhaust gas 90 exits the system via an exhaust collector 550 and may be further processed (e.g., to reduce harmful emissions, and/or to recover heat from the exhaust gas 90).

During the manufacture or repair of gas turbine engines, the gas turbine engine components, including the compressor rotor 210 and weldments may be coated with a protective coating, such as an aluminum spray coating. Paper masking cards and tape may be used to cover the axial slots 235 and the circumferential slots 236 in each compressor disk 220. Paper masking cards or tape may be insufficient in preventing overspray from occurring. In particular paper masking cards or tape may be insufficient in preventing overspray within the axial slots 235.

Overspray within axial slots 235 and circumferential slots 236 may cause fretting or wear within the axial slots 235 and the circumferential slots 236. The overspray may also cause fretting or wear on the axial blades 229 and the circumferential blades 230. Fretting or wear may lead to a shortened operational life of these components and an increase in repair costs.

Masking fixtures may reduce or prevent overspray within axial slots 235. Masking fixtures may be composed of a durable material that substantially covers the surfaces of axial slots 235 during the coating process. Masking fixtures may remain in place during some drying processes as well.

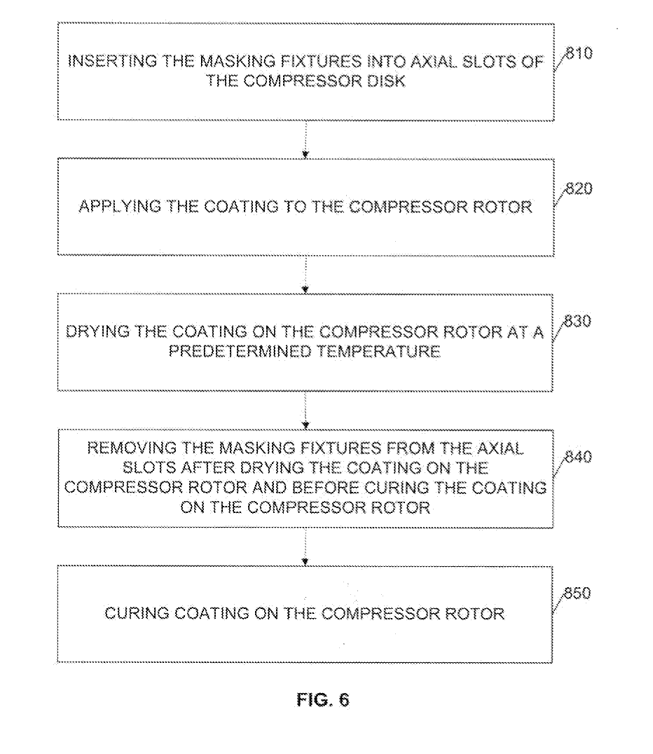

FIG. 6 is a flowchart of a method for coating a gas turbine engine compressor rotor 210 with at least one compressor disk 220. The method may include coating a weldment such as forward weldment 211. The method includes inserting masking fixtures, such as masking fixtures 700a and 700b, into axial slots 235 of the compressor disk as step 810. Each masking fixture may include a rigid masking root that is the negative of the axial slot 235 it is inserted into or matches the shape of the airfoil root of the axial blade 229 that will be inserted into th compressor disk 220. Each masking fixture is inserted into an axial slot 235 in the axial direction. Masking fixtures may be inserted into the axial slots 235 by sliding the masking fixtures into the axial slots 235 in the axial direction. Masking fixtures may be used more than once for the coating method.

Step 810 is followed by applying the coating to the compressor rotor 210 at step 820. The coating applied may be a protective coating such as an aluminum spray coating. Step 820 is followed by drying the coating on the compressor rotor 210 at a predetermined temperature after applying the coating to the compressor rotor 210 and before curing the coating on the compressor rotor 210 at step 830. Drying the compressor rotor 210 may also be considered a pre-curing step. In one embodiment, drying the coating on compressor rotor 210 includes heating the compressor rotor 210 above 37.8 degrees Celsius (100 degrees Fahrenheit). In another embodiment, drying the coating on the compressor rotor 210 includes heating the compressor rotor to 93.3 degrees Celsius (200 degrees Fahrenheit). In some embodiments, removing the masking fixtures is performed after drying the compressor rotor 210. In other embodiments, the masking fixtures may be removed prior to the pre-curing step.

Step 830 is followed by removing masking fixtures from each axial slot 235 after drying the coating on the compressor rotor 210 and prior to curing the coating on the compressor rotor 210 at step 840. Step 840 is followed by curing the coating on the compressor rotor 210 at step 850. Curing the compressor rotor 210 may include heating the compressor rotor 210 to temperatures in excess of 315.6 degrees Celsius (600 degrees Fahrenheit).

The method may also include grit blasting the compressor rotor prior 210 to applying the coating to the compressor rotor 210. Materials such as alumina or steel shot may be used for grit blasting. The masking fixtures may be inserted prior to grit blasting the compressor rotor 210. In one embodiment, the masking fixtures are cleaned after grit blasting and before applying the coating. In another embodiment, the masking fixtures are removed and replaced with clean masking fixtures after grit blasting and before applying the coating.

The masking fixtures may also be inserted after grit blasting. In one embodiment, the compressor rotor 210 is masked with tape and paper prior to grit blasting; after grit blasting the tape and paper are removed and the masking fixtures are inserted. The compressor rotor may also be inspected after the grit blasting and before applying the coating. In some embodiments, the compressor rotor 210 is cleaned at a predetermined temperature prior to grit blasting.

Some compressor rotors 210 or weldments include compressor disks 220 with axial slots 235 and compressor disks 220 with a circumferential slot 236. In any of the above mentioned embodiments, the circumferential slots 236 may be masked with tape and paper while the axial slots 235 are masked with masking fixtures.

The preceding detailed description is merely exemplary in nature and is not intended to limit the invention or the application and uses of the invention. The described embodiments are not limited to use in conjunction with a particular type of gas turbine engine. Hence, although the present disclosure, for convenience of explanation, depicts and describes particular masking fixtures for compressor rotors, it will be appreciated that the masking fixtures and the methods for using the masking fixtures in accordance with this disclosure can be implemented in various other configurations, and can be used with various other types of gas turbine engine rotors and rotor disks, including turbine rotors and turbine disks. Furthermore, there is no intention to be bound by any theory presented in the preceding background or detailed description. It is also understood that the illustrations may include exaggerated dimensions to better illustrate the referenced items shown, and are not considered limiting unless expressly stated as such.

What is claimed is:

1. A method for coating a gas turbine engine compressor rotor including a compressor disk having axial slots, the method comprising:
inserting masking fixtures into the axial slots, each masking fixture including a masking root that matches the shape of a blade root of an axial blade configured to be inserted into the axial slot the masking fixture is inserted into;
applying a coating to the compressor rotor after inserting the masking fixtures into the axial slots;
drying the coating on the compressor rotor at a predetermined temperature after applying th coating to the compressor rotor and before curing the coating on the compressor rotor;
removing the masking fixtures from the axial slots after drying the coating on the compressor rotor and before curing the coating on the compressor rotor; and
curing the coating on the compressor rotor.

2. The method of claim 1, further comprising grit blasting the compressor rotor prior to applying the coating to the compressor rotor.

3. The method of claim 2, wherein the masking fixtures are inserted into the axial slots prior to grit blasting the compressor rotor.

4. The method of claim 1, wherein the masking fixtures completely fill each axial slot.

5. The method of claim 1, wherein each masking fixture includes a handle extending from an outer surface of the masking root.

6. The method of claim 1, wherein each masking fixture includes a masking platform extending from the masking root and overhanging a portion of an outer surface of the compressor rotor, the masking platform and masking root forming a T-shaped cross-section.

7. The method of claim 1, wherein applying the coating includes spraying an aluminum spray coating onto the compressor rotor.

8. The method of claim 1, wherein the compressor rotor includes a weldment with multiple compressor disks welded together.

9. The method of claim 8, wherein the compressor rotor includes a weldment with a circumferential slot and the circumferential slot is covered with tape and masking paper prior to applying the coating.

10. A gas turbine engine compressor rotor manufactured using the method of claim 1.

11. The method of claim 1, wherein the masking fixture has a heat deflection temperature greater than 93.3 degrees Celsius.

12. A method for coating a gas turbine engine rotor with a rotor disk having axial slots, the method comprising:
grit blasting the gas turbine engine rotor prior to applying the coating to the gas turbine engine rotor;
sliding masking fixtures into the axial slots, each masking fixture including a masking root that matches the shape of a blade root of an axial blade configured to be inserted into the axial slot the masking fixture is inserted into;
applying a coating to the gas turbine engine rotor after sliding the masking fixtures into the axial slots;
drying the coating on the gas turbine engine rotor at a predetermined temperature after applying the coating to the gas turbine engine rotor and before curing the coating on the gas turbine engine rotor;
sliding the masking fixtures out of the axial slots after drying the coating on the gas turbine engine rotor and before curing the coating on the gas turbine engine rotor; and
curing the coating on the gas turbine engine rotor.

13. A gas turbine engine rotor manufactured using the method of claim 12.

14. A masking fixture for inserting into a gas turbine engine compressor disk axial slot during a coating process, the masking fixture comprising:
a masking root having a shape that matches the shape of a blade root of an axial blade configured to be inserted into the axial slot the masking fixture is inserted into; and
a material having a heat deflection temperature greater than 93.3 degrees Celsius;
wherein the masking root is configured, to cover all portions of the axial slot that contact the axial blade.

15. The masking fixture of claim 14, further comprising a handle extending from an outer surface of the masking root.

16. The masking fixture of claim 14, further comprising a masking platform extending from the masking root, the masking platform configured to overhang a portion of an outer surface of a compressor disk, the masking platform and masking root forming a T-shaped cross-section.

17. The masking fixture of claim 14, wherein the masking root completely fills the axial slot.

18. The masking fixture of claim 14, wherein the material is a polymer.

19. The masking fixture of claim 18, wherein the polymer includes polyphenylsulfone.
